(19) United States
(12) Patent Application Publication
(10) Pub. No.: US 2003/0045315 A1
(43) Pub. Date: Mar. 6, 2003

(54) Multi-icon display

(76) Inventor: Yojak Vasa, Morrisville, NC (US)

Correspondence Address: MOORE & VAN ALLEN, PLLC, 2200 W MAIN STREET, SUITE 800, DURHAM, NC, 27705, US

(21) Appl. No.: 09/945,095

(22) Filed: Aug. 31, 2001

(51) Int. Cl. H04B 7/00

(52) U.S. Cl. 455/517; 455/566

(57) ABSTRACT

Multi-Icon Display. The present invention provides a mobile terminal with a display for making better use of the available screen space in order to provide icons for informing the user of all the various system operating parameters. The multi-icon display displays icons in an area of a display and display a meta-icons with a second area in the space surrounding the display space of the icons. Each icon and meta-icon is representative of a particular metric. In one embodiment, the invention comprises a memory for storage of data, a display for graphical user interface, and a control circuit that is configured to control a flow of data between the memory and the display and the appearance of information upon the display.

### BACKGROUND OF THE INVENTION

The present invention relates generally to graphical user interfaces (GUIs) for mobile terminals and is particularly directed to a cellular telephone of the type that includes a computer-controlled graphics display.

Various types of mobile terminals have been available for many years having displays for presenting various icons, or symbols, that each represent information related to system performance or features. These icons frequently include one or more informative “metrics” to indicate various system operating parameters, such as battery life or signal strength. Due to their small size, mobile terminals have a very limited amount of display space on which to display icons. As more features are added to mobile terminals that require display, it is becoming more difficult to display all of the icons a user would like to view because of the lack of display space.

It would be desirable to provide a mobile terminal with a display that makes better use of the available screen space in order to provide icons for informing the user of all the various system operating parameters. Additionally, it is desirable to have a display of information that avoids user confusion.

### BRIEF SUMMARY OF THE INVENTION

The present invention provides a mobile terminal with a display for making better use of the available screen space in order to provide icons for informing the user of all the various system operating parameters. The display of information also avoids user confusion. The invention solves the above problems by displaying icons in an area of a display and displaying a meta-icon within a second area in the space surrounding the display space of the icons. Each icon and meta-icon is representative of a particular metric. Because the meta-icon surrounds the display space of the icons, the display space of the mobile terminal is conserved. This provides for more display space for other graphical user interface to be presented. In one embodiment, the invention comprises a memory for storage of data, a display for graphical user interface, and a control circuit that is configured to control a flow of data between the memory and the display and the appearance of information upon the display. A set of areas, each area in a space of the display, is provided in the display to each depict an icon. Each icon is representative of a particular metric. Additionally, a second area is provided in a space of the display surrounding the display space of the set of areas to depict a meta-icon representative of another particular meter.

According to an embodiment of the invention, the metrics comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator.

According to another embodiment of the invention, the invention includes a memory, control circuit, and a display. The invention provides a graphical user interface by displaying an icon, each icon representative of a particular metric, within each area of a set of areas in display space. Additionally, the invention displays a meta-icons, the meta-icon representative of another particular metric, within a second area in the display space surrounding the display space of the set of areas.

These and other advantages of the present invention will become apparent to those skilled in the art upon a reading of the following specification of the invention and-a study of the several figures of the drawings.

### BRIEF DESCRIPTION OF THE DRAWINGS

FIG. 1 illustrates a block diagram of the internal components of the present invention.

FIG. 2 illustrates a mobile terminal in accordance with the present invention.

FIG. 3 illustrates the total display area of a mobile terminal operating in accord with an embodiment of the present invention.

FIG. 4 illustrates a block diagram of the software configured to control the flow of data between the memory and the display and the appearance of information upon the display.

### DETAILED DESCRIPTION OF THE INVENTION

The present invention includes a mobile terminal that provides a graphical user interface on a display. While the present invention is described herein in the context of a mobile terminal, the term “mobile terminal” may include a cellular radiotelephone with or without a multi-line display; a Personal Communications System (PCS) terminal that may combine a cellular telephone with data processing, facsimile and data communications capabilities; a Personal Digital Assistant (PDA) that can include a radiotelephone, pager, Internet/intranet access, Web browser, organizer, calendar and/or a global positioning system (GPS) receiver; and a conventional laptop and/or palmtop receiver or other computer system that includes a display for GUI. Mobile terminals may also be referred to as “pervasive computing” devices. In one embodiment of the invention, the invention may be implemented on a computer system having a memory circuit for storage of data, a display which acts as a graphical user interface, and a control circuit that is configured to control the flow of data between the memory and display and the appearance of information upon the display.

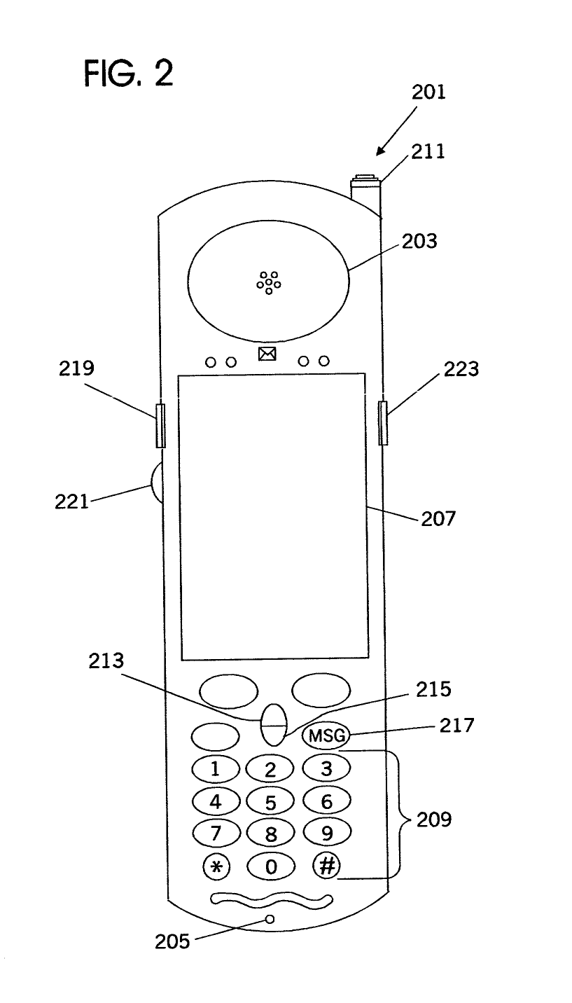

FIG. 2 illustrates a mobile terminal in accordance with the present invention. In one embodiment, the mobile terminal 201 is a cellular radiotelephone, which may be conventional except as provided otherwise in this description. The terminal 201 includes an earpiece 203 for outputting sound, a mouthpiece 205 for inputting sound, and a display 207. As will be described below, the display 207 is used to present the GUI to the user of the mobile terminal 201, using which the user can control all significant functions of the terminal. In one embodiment, the display 207 is a bit-mapped, gray-scale screen. The display 207 can be a liquid crystal display (LCD) or any other suitable type of display device such as a color display. The terminal 201 also includes a keypad 209, which includes standard alphanumeric keys, such as are found on many conventional mobile terminals, and an extendible antenna 211 for transmitting and receiving data over a wireless (e.g., cellular) connection. The terminal 201 also includes various other controls, some of which are used with the features to be described below. In particular, the terminal 201 includes a Scroll Up button 213, a Scroll Down button 215, a Messages button 217, a Send button 219, a Volume/Scroll Up/Down button 221, and an End button 223.

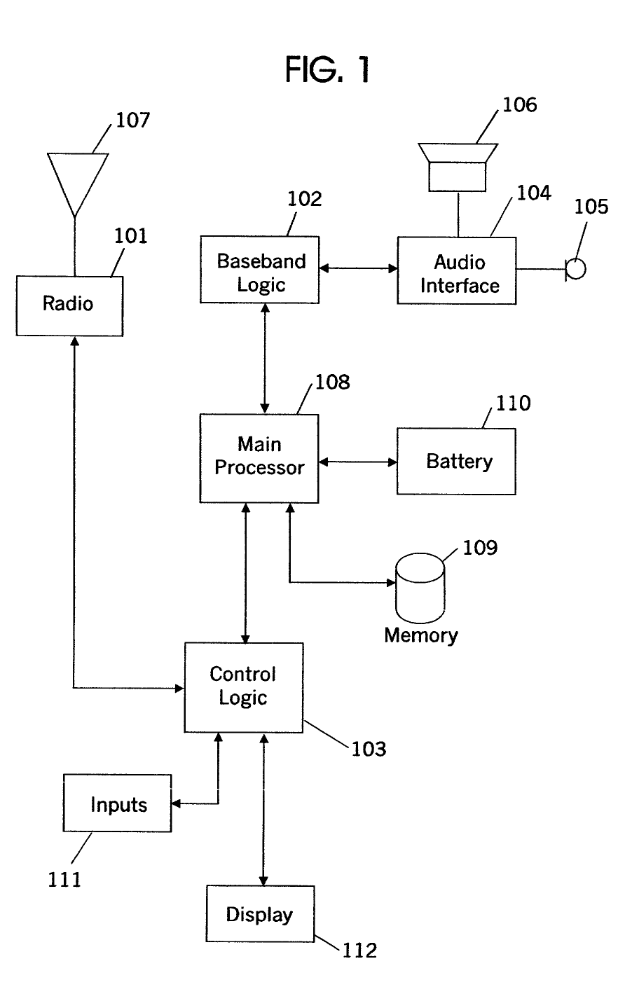

Referring now to FIG. 1, a block diagram of the internal components of the present invention is illustrated. This illustration is for example only, and the invention works equally well with mobile terminals that are dedicated to communicating with text or other forms of data. As shown in FIG. 1, the mobile terminal includes a radio block 101, a baseband logic block 102, a control logic block 103, and an audio interface block 104. Within radio block 101, the receive and transmit information is converted from and to the radio frequencies (RF) of the various carrier types, and filtering using baseband or intermediate frequency circuitry is applied, as is understood in the art. The terminal's antenna system 107 is connected to the radio block. In baseband logic block 102, basic signal processing occurs, e.g., synchronization, channel coding, decoding and burst formatting, as is understood in the art. Audio interface block 104 handles voice as well as analog-to-digital (A/D) and D/A processing. It also receives input through a microphone 105, and produces output through speaker 106. Control logic block 103, coordinates the aforementioned blocks and also plays an important role in controlling the human interface components such as inputs 111 (representing buttons 213 through 223) and display 112 (representing the display of FIG. 2). The circuitry for directing and controlling the flow of data between the memory, the telephony circuit, and the display and for further controlling the appearance of information upon the display is herein collectively referred to as the “control circuit”. The functions of the aforementioned blocks are directed and controlled by processing circuitry such as general-purpose microprocessors, digital signal processors (DSPs), application specific integrated circuits (ASICs), various types of signal conditioning circuitry, including analog-to-digital converters, digital-to-analog converters, input/output buffers, etc. Program code, often in the form of microcode is stored in memory 109 and controls the operation of the terminal through the processor or processors. Some aspects of the invention are implemented in some embodiments by the program code controlling the hardware.

The memory 109 may include one or more physical memory devices, which may include volatile storage devices, non-volatile storage devices, or both. For example, memory 109 may include both random access memory (RAM), read-only memory (ROM), various forms of programmable and/or erasable (ROM) (e.g., PROM, EPOM, EEPROM, etc.), flash memory, or any combination of such devices.

The present invention includes steps which, in various embodiments, may be carried out by elements of the main processor 108 executing sequences of instructions. The instructions may be stored in the memory 109. Software instructions (or data) may be loaded into the terminal 201 from another device, such as a remote computer system, over the wireless connection. In various embodiments, downloaded software instructions may be directly supported by the terminal 201, in which case execution of the instructions may be performed directly upon their being received. In other cases, downloaded instructions may not be directly executable by the terminal 201. Under these circumstances, the instructions may be executed using an interpreter, which interprets the instructions, or by otherwise executing instructions which convert the received instructions to instructions that can be directly executed.

Certain embodiments of the present invention may be carried out by hard-wired circuitry, rather than by executing software, or by a combination of hard-wired circuitry with software. Hence, it will be recognized that the present invention is not limited to any specific combination of hardware circuitry and software, nor to any particular source for software instructions.

To facilitate description it is henceforth assumed that aspects of the present invention are generally carried out through the execution of software instructions in the terminal 20. It is envisioned that these instructions may be written in the Java language, or alternatively in C or C++. Note, however, that other languages may be substituted within the scope of the present invention. As is well-known, Java is an application designed specifically for network-connectable applications on consumer devices. The details of developing software in Java is well-known to those skilled in the relevant art and are not required for an understanding of the present invention. Accordingly, such details are not provided herein.

As understood, mobile terminals can be configured to act as a very powerful and versatile piece of communications equipment, and with the proper software, also can act as a portable computer having such applications as an organizer, etc. They can provide a display that is similar to a Windows-based GUI as known in the art. However, since the display is physically smaller than monitor screens common to most systems running Windows-based GUIs that are provided with personal computers or laptop computers, the icons required for telephone operation such as battery strength and signal strength and those typically presented with personal computers or laptops may not be easily used without some modifications.

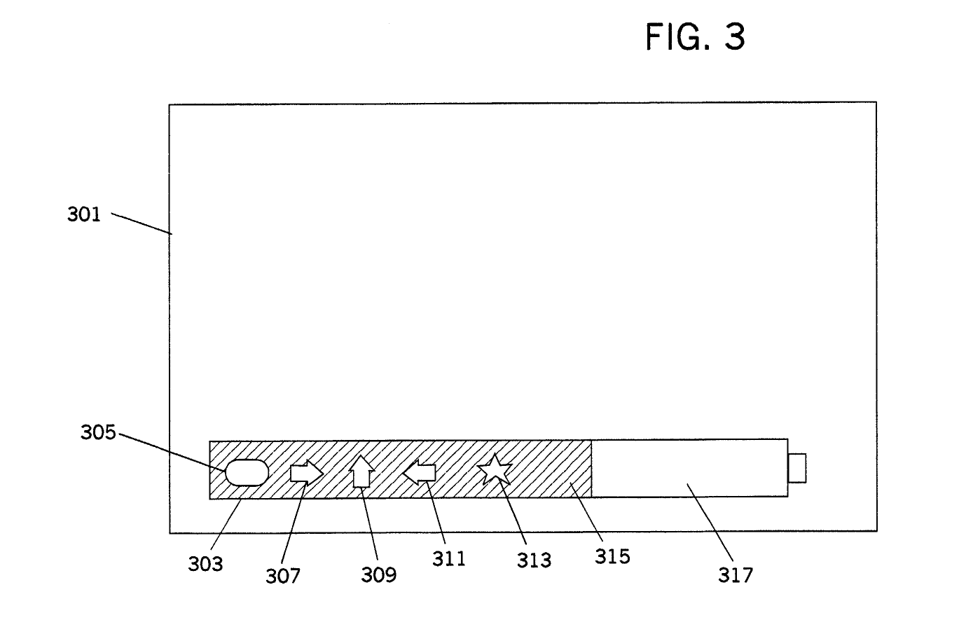

In the present invention, certain applications and metrics, representing information related to system performance, are presented on the graphical user interface as either icons and meta-icons, which serve to conserve display space while reducing confusion for the user by providing a display with features that a user wants to observe on the display at one time. A metric might be either a variable quantity such as signal strength, or it may represent an on/off or binary condition such as whether E-mail has been received. The use herein of the word “metric” represents a “small” application program that constantly monitors the computer system in the background (or checks the system periodically), and displays the information graphically. FIG. 3 illustrates the total display area 301 of a mobile terminal operating in accord with an embodiment of the present invention.

Various types of information are displayed using icons and other symbols on the display 301, such as a mailbox that raises a flag if new E-mail has arrived. On a device having a small display screen, however, there may not be enough area to show the user all of the information required by various informative metrics. The relatively small display area, designated by reference numeral 303, represents a meta-icon that causes an area in a space of the display to act as a battery power indicator in this embodiment. The area 303 occupied by the meta-icon is provided to depict a meta-icon representation of the battery metric. The area designated by reference numeral 303 surrounds a set of areas, each in a space of the display. Each area of the set of areas depicts one icon, which are each representative of a particular metric. The set of areas are each designated at reference numerals 305, 307, 309, 311, and 313. Any of the metrics may be depicted to indicate such information as battery power, signal strength, memory usage, clock indicator, interrupt indicator, serial port indicator, keyboard indicator, volume indicator, speaker phone indicator, handset off hook indicator, messaging indicator, handset out of range indicator, and audio path indicator.

In the illustrated example of FIG. 3, the meta-icon represents a battery power indicator for the mobile terminal 201. The symbol at display area 301 generally resembles a battery in appearance and appears also as a bar graph which indicates the amount of charge remaining in the battery that powers the mobile terminal 201. In this embodiment, the shaded portion 315 represents the amount of total capacity charge remaining in the battery 110. The unshaded portion 317 represents the amount of total capacity charge depleted from the battery 110. Alternatively, the charge of the battery can be represented in color or any such depiction for graphically representing the strength of a battery or other such metric. Additionally, the space occupied by the current meta-icon may change to display another one of a variety of meta-icons representative of a particular metric at a user's command or automatically. The meta-icon and the associated icons surrounded by the display area of the meta-icon are displayed at a lower space of the display 301 in this illustrated example, however, it may be located anywhere in the space of the display 301.

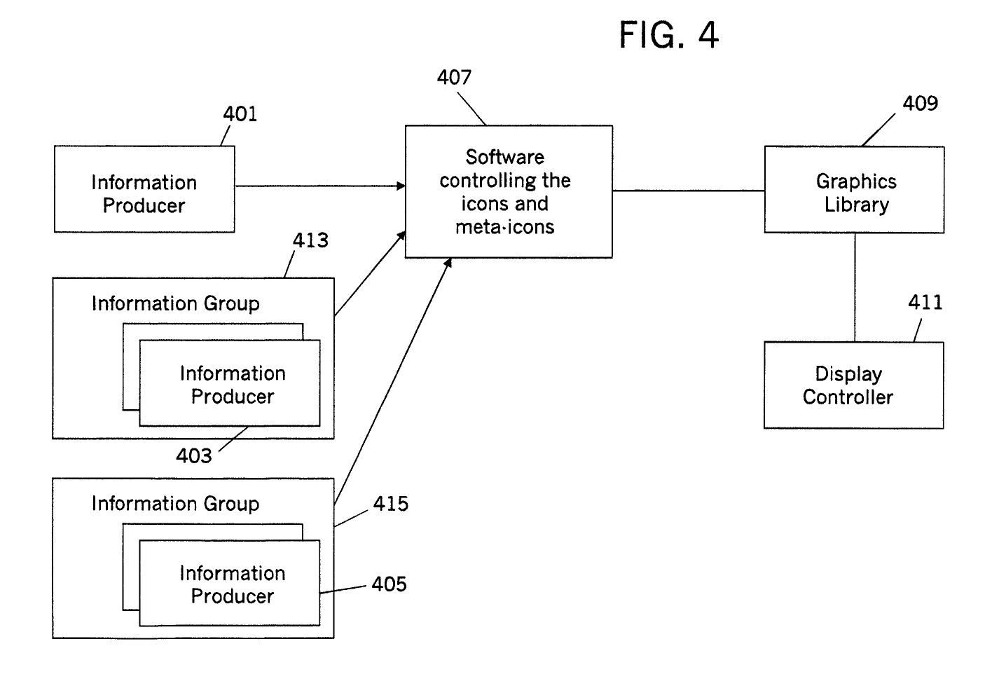

Referring now to FIG. 4, a block diagram of the software configured to control the flow of data between the memory and the display and the appearance of information upon the display is illustrated. Several information producers are designated at reference numerals 401, 403, and 405. Reference numeral 401 depicts one information producer. Reference numerals 403 and 405 each designate a set of information producers. Information producers are applications which provide the software application 407 controlling the graphic display of the icons and meta-icons with notification of changes to the state of the information to which they are related. The information producers in the embodiment are both hardware and software-based. For example, the battery is hardware-based, and the E-mail is a software-based information producer. When the software 407 is notified of a change of the state of information, the control software 407 determines how to effect the change on the display 301 and which application in the graphics library 409 to access and notify to effect the change. The graphics library 409 provides specific information to the display controller 411 for effecting any necessary change of the icon or meta-icon in the display 201. The control software 407 controlling the icons and meta-icons has information related to each graphic provided on the display 201. The display controller 411 provides software control for the control logic hardware 103 for directing the graphics provided on the display 112.

In another embodiment, the control software 407 relates the information for related groups of icons into a set of icons inside a meta-icons to facilitate ease of use to a user. For example, for icons related to telephone use such as a receive call icon or a message icon would be related to a signal strength meta-icon. Therefore, these related icons are grouped together and surrounded by the display space provided for the signal strength meta-icon. These information producers are grouped together in software as an information group, designated at reference numerals 413 and 415. An information producer, such as the information producer designated by reference numeral 401, may not be mapped to a group. The information groups relate to meta-icons and the individual information producers relate to icons.

While a preferred form of the invention has been shown in the drawings and described, since variations in the preferred form will be apparent to those skilled in the art, the invention should not be construed as limited to the specific form shown and described, but instead is as set forth in the following claims.

1. A computer system, comprising:
a memory for storage of data;
a display for graphical user interface; and
a control circuit that is configured to control a flow of data between the memory and the display and the appearance of information upon the display,
wherein a set of areas, each area in a space of the display, is provided to each depict an icon, each icon representative of a particular metric,
wherein a second area, the second area in a space of the display surrounding the display space of the set of areas, is provided to depict a meta-icon representative of another particular metric.

2. The computer system as recited in claim 1, wherein the metrics comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator

3. The computer system as recited in claim 1, wherein the particular metrics of the icons and meta-icons are related to one another for facilitating ease of use to a user.

4. A mobile terminal, comprising:
a telephony circuit;
a memory for storage of data;
a display for graphical user interface; and
a control circuit that is configured to control a flow of data between the telephony circuit; the memory, and the display, the control circuit further controlling the appearance of information upon the display,
wherein a set of areas, each area in a space of the display, is provided to each depict an icon representative of a particular metric,
wherein a second area, the second area in a space of the display surrounding the display space of the set of areas, is provided to depict a meta-icon representative of another particular metric.

5. The mobile terminal as recited in claim 4, wherein the metric comprises a signal strength indicator relating to a relative quantity of signal amplitude received by the telephony circuit.

6. The mobile terminal as recited in claim 4, wherein the metric comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator.

7. The mobile terminal as recited in claim 4, wherein the telephony circuit comprises a cellular telephone that is in communication with the control circuit, wherein data received by the cellular telephone is displayed on the display.

8. The mobile terminal as recited in claim 7, wherein the metric comprises a signal strength indicator relating to a relative quantity of signal amplitude received by the cellular telephone.

9. The mobile terminal as recited in claim 4, wherein the particular metrics of the icons and meta-icons are related to one another for facilitating ease of use to a user.

10. In a computer system including a memory, a control circuit, and a display, a method of providing a graphical user interface, comprising:
displaying an icon, each icon representative of a particular metric, within each area of a set of areas in display space; and
displaying a meta-icon, the meta-icon representative of another particular metric, within a second area in the display space surrounding the display space of the set of areas.

11. The method as recited in claim 10, wherein the metric comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator.

12. The method as recited in claim 10, wherein the particular metrics of the icons and meta-icons are related to one another for facilitating ease of use to a user.

13. In a computer system including a memory, a control circuit, and a display, a method of providing a graphical user interface, comprising:
configuring, under the control of a control circuit, a set of areas in a space of the display that, after being activated, each display an icon, each icon representative of a particular metric; and
configuring, under the control of the control circuit, a second area in a space of the display surrounding the display space of the set of areas that, after being activated, displays a meta-icon representative of another particular metric.

14. The method as recited in claim 13, wherein the metric for the meta-icon includes comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator

15. The method as recited in claim 13, wherein the particular metrics of the icons and set of icons are related to one another for facilitating ease of use to a user.

16. Apparatus for providing a graphical user interface, comprising:
a memory;
a control circuit;
a display;
means for displaying an icon, each icon representative of a particular metric, within each area of a set of areas in display space; and
means for displaying a meta-icon, the meta-icon representative of another particular metric, within a second area in the display space surrounding the display space of the set of areas.

17. Apparatus of claim 16, wherein the metric of the meta-icon includes comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator

18. Apparatus of claim 16, wherein the particular metrics of the icons and set of icons are related to one another for facilitating ease of use to a user.

19. A computer program product for providing a graphical user interface, the computer program product including a computer program comprising:
instructions for displaying an icon, each icon representative of a particular metric, within each area of a set of areas in display space; and
instructions for displaying a meta-icon, the meta-icon representative of another particular metric, within a second area in the display space surrounding the display space of the set of areas.

20. The computer program product of claim 19, wherein the metric comprises one of a battery power indicator, signal strength, memory usage indicator, clock indicator, interrupt indicator, serial port indicator, keyboard indicator, volume indicator, speaker phone indicator, handset off hook indicator, messaging indicator, handset out of range indicator, and audio path indicator

21. The computer program product of claim 19, wherein the particular metrics of the icons and set of icons are related to one another for facilitating ease of use to a user.
